(19) United States
(12) Patent Application Publication
(10) Pub. No.: US 2008/0201658 A1
(43) Pub. Date: Aug. 21, 2008

(54) Wireless Media Player Device and System, and Method for Operating the Same

(75) Inventors: Tamio Saito, San Jose, CA (US); Juergen F. Kienhoefer, Santa Cruz, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: IVI Smart Technologies, Inc., New York, NY (US)

(21) Appl. No.: 11/758,575

(22) Filed: Jun. 5, 2007

Related U.S. Application Data
(60) Provisional application No. 60/811,224, filed on Jun. 5, 2006.

(51) Int. Cl. G06F 3/048; G06F 17/00

(52) U.S. Cl. 715/772; 700/94; 715/771

(57) ABSTRACT

A wireless media player device includes (a) a flash memory, (b) a main processor adapted to process digital signals and to control wireless communications, the main processor including first and second interfaces adapted to wirelessly communicate with an external host computer and an external headset, respectively, (c) a signal antenna coupled to the main processor, (d) a power circuit coupled to the main processor, adapted to provide power to components of the media player device, (e) a wireless charger adapted to receive power from an external power source and charge the power circuit, and (f) a display provided on a surface of the media player device. The media player device is wearable and may further includes a casing and an attacher (such as a wrist band) adapted to fasten the media player device onto a user such that the display is visible from the user.

### CROSS-REFERENCE TO RELATED APPLICATIONS

The present disclosure may be related to the following commonly assigned applications/patents:

This application claims priority from co-pending U.S. Provisional Patent Application No. 60/811,224 filed Jun. 6, 2006 entitled “WIRELESS MEDIA PLAYER DEVICE AND SYSTEM, AND METHOD FOR OPERATING THE SAME” which is hereby incorporated by reference, as if set forth in full in this document, for all purposes.

The respective disclosures of these applications/patents are incorporated herein by reference in their entirety for all purposes.

### FIELD OF THE INVENTION

The present invention relates to a wireless media player device. More particularly, the present invention relates to wearable media player device which is fully wirelessly operable, a system including the same, and a method for operating the same.

### BACKGROUND OF THE INVENTION

Portable media players, such as iPod™ devices, available from Apple Computer, Inc., Cupertino, California, and other MP3 players, are typically carried in a case which may be attached or hooked to a waist belt, bag, purse, or the like. Such a case may also be wearable around the neck. Headphones or earphones are typically plugged in, for example, to a Headphones and AV port of an iPod™.

Wireless headphones are also available for such MP3 players. For example, Logitech® Bluetooth Headphones for iPod™, available from Logitech, Inc., Fremont, Calif., has a wireless adapter which connects directly to an iPod™ and transmits signals using Bluetooth technology. The user can adjust volume, select, play, and pause tracks from the wireless headset. The wireless adapter uses the same plug-in port for the wired headphones and earphones (and the remote port) of an iPod™.

Some companies also offers FM transmitters for iPod™, for example, iTrip®, available from Griffin Technology, Nashville, Tenn., which send audio signals (music) wirelessly from the iPod™ to any FM radio in the user's car, house, party place, and the like. Such FM transmitters also directly connect to the iPod™ via the Headphone and AV port and the Remote port thereof.

### BRIEF SUMMARY OF THE INVENTION

A wireless media player device includes (a) a flash memory, (b) a main processor adapted to process digital signals and to control wireless communications, the main processor including first and second interfaces adapted to wirelessly communicate with an external host computer and an external headset, respectively, (c) a signal antenna coupled to the main processor, (d) a power circuit coupled to the main processor, adapted to provide power to components of the media player device, (e) a wireless charger adapted to receive power from an external power source and charge the power circuit, and (f) a display provided on a surface of the media player device. The media player device is wearable and may further include a casing and an attacher (such as a wrist band) adapted to fasten the media player device onto a user such that the display is visible from the user.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a block diagram schematically illustrating a wireless media player device in accordance with one embodiment of the present invention.

FIGS. 2A and 2B are diagrams schematically illustrating examples of the media player device in accordance with one embodiment of the present invention.

FIG. 3 is a diagram schematically illustrating a method for operating a wireless media player in accordance with one embodiment of the present invention.

### DETAILED DESCRIPTION OF THE INVENTION

Embodiments of the present invention are described herein in the context of a wireless media player device and system, and a method for operating the same. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

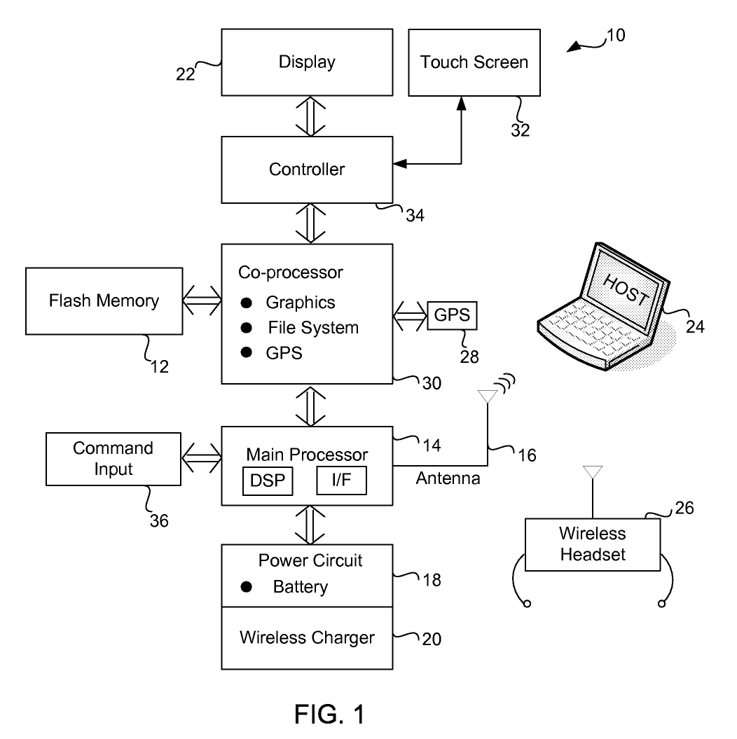

FIG. 1 schematically illustrates a wireless media player device 10 in accordance with one embodiment of the present invention. The media player 10 stores and plays media files such as MP3 (MPEG audio layer 3) or MP4, in cooperation with a wireless headset or headphones. The media player device 10 includes a flash memory 12, a main processor 14, a signal antenna 16 for wireless communications, a power circuit 18, a wireless charger 20, and a display 22. The main processor 14 is adapted to process digital signals and control wireless communications. For example, the main processor 14 includes a digital signal processor (DSP), a first interface adapted to wirelessly communicate with an external host computer 24, and a second interface adapted to wirelessly communicate with an external headset 26. The communications between the media player device 10 and the host computer 24, and that between the media player device 10 and the headset 26 may use the wireless USB (WUSB) based on ultra wideband wireless technology (IEEE 802.13.3a), the Bluetooth standard (IEEE 802.15.1), or the like. The first and second interfaces may be integrated in one if both of them use the same standard.

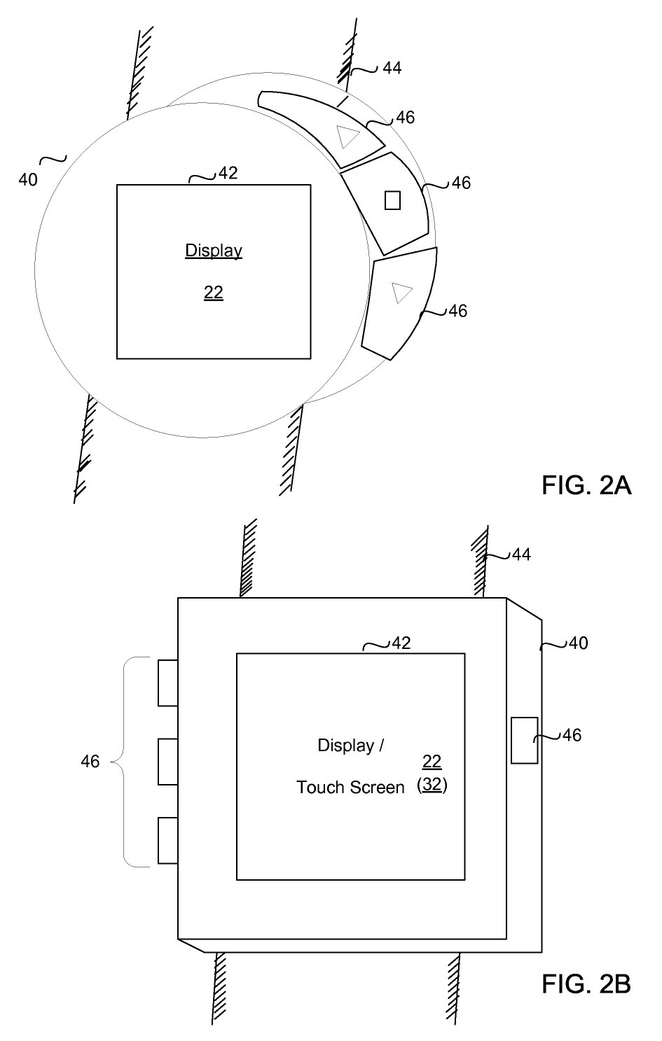

FIGS. 2A and 2B schematically illustrate examples of the exterior of the wireless media player device 10 in accordance with one embodiment of the present invention, where the media player device 10 is a wearable device. As shown in FIGS. 2A and 2B, the media player device 10 includes a casing 40 and an attacher 44. The casing 40 protects the media player device 10, while exposing the display 22 (and a touch screen 32 as described below) on the top surface thereof through an opening. The shape of the casing 40 may be round, square, or polygon-shaped. The shape of the opening (and thus that of the display 22) may also be round, square, or polygon-shaped. The attacher 44 is adapted to fasten the media player device 10 onto a user such that the display 22 is visible from the user. For example, the attacher 44 is in a form of a wrist band such that the media player device 10 is worn in the same manner as a wrist watch. Although the present invention is not limited to the wrist watch type, wearing the media player 10 on the wrist is very convenient to view, access, and control it.

The media player device 10 is fully operable and playable without being in direct contact with any external devices, such as a power source, host computer, and headphones. That is, all of the communications and interactions, such as charging, downloading, and reproducing from headphones are performed wirelessly. Thus, the media player device 10 may lack such direct contact connectors.

Referring back to FIG. 1, the main processor 10 may wirelessly download digital data, such as audio files (MP3, MP4), from the host computer 24. The flash memory 12 stores the downloaded digital data. When the user listens to the music, for example, the stored digital data is read from the flash memory 12, encoded into a selected data format, if desired, and then wirelessly transmitted to the headset 26. For example, if the audio files are in the MP3 format, the MP3 files may be encoded (compressed) using the Bluetooth Sub-Band CODEC (SBC) for wireless transmission. In accordance with one embodiment of the present invention, at least one co-processor 30 may be provided to handle the media files stored in the flash memory 12. The co-processor 30 controls reads/writes of the digital data from/to the flash memory 12 and manages files. The main processor 10 performs the SBC encoding and sends the encoded data to the headset 26 via the antenna 16. The headset 26 includes a corresponding SBC decoder and other necessary circuitry (not shown) to play the received audio files.

The power circuit 18 includes a rechargeable battery, and is coupled to the main processor 14. The power circuit 18 provides the power to components of the media player device 10. The wireless charger 20 is coupled to the power circuit 18, and may be part of the power circuit 18. The wireless charger 20 receives power from an external power source (not shown), and charges the power circuit (the battery). For example, the wireless charger 20 includes a coil or power antenna so as to receive electromagnetic energy from an electromagnetic field generated by the external source.

The wireless media player device 10 may further include a global positioning system (GPS) circuit 28 coupled with the co-processor 30. The co-processor 30 may also control the GPS circuit 28.

The display 22 is provided on the surface of the media player device 10 such that it can be viewed by a user. The wireless media player device 10 may further include a display controller 34 coupled to the co-processor 34, which is dedicated to control the display 22. The display 22 may display at least one of the following items: an indication of a status of data which is being transmitted or downloaded; an indication of the data stored in the flash memory; the current date and time; a position of the apparatus in accordance with the GPS; a strength of a signal being received; the title of a music piece or audio file being played, and a battery status. For example, a small icon may be flashing or blinking when a file is being downloaded, or an audio file is being transmitted (i.e., being reproduced form the headset) to indicate the process. A list of the file names stored in the flash memory 12 may be presented in response to a user command.

In accordance with one embodiment of the present invention, the wireless media player device 10 may further include a touch screen 32 to provide a user input device integrated with the display 22. The display 22 may be a flexible polymer film display, and displays one or more control buttons in addition to the items described above. The display screen may have a display mode to indicate various information and an input mode to receive a user's input via the touch screen. The user presses a displayed control button to enter a corresponding command. The display controller 34 may be configured so as to determine the depressed position (for example, display coordinates) and send the position signal to the co-processor 30. The co-processor 30 processes the input commands as well as controlling graphics through the display controller 34. The input commands may be sent to the main processor 14 to respond.

In accordance with one embodiment of the present invention, the wireless media player device 10 may further include an input device 36 adapted to input a user's control command, such as at least one control button 46 (see FIGS. 2A and 2B) provided on the surface of the player device 10. As shown in FIGS. 2A and 2B, the control button may be provided on the side(s) of the watch-type casing 40. The input from the control button(s) 46 may be directly processed by the main processor 14. The control button 46 may be used as an on/off switch, to change the display mode, for example, from a “date/time/current position” mode to a “music playing” mode to a “command input” mode, and the like. The control button 46 may also be used to adjust volume, play, pause, or select tracks, or scroll the display screen.

In accordance with one embodiment of the present invention, the media player device 10 may also be controlled from the headset 26. In this case, the second interface in communication with the headset 26 is capable of receiving a user's commands which are wirelessly transmitted from external headset 26. For example, the headset 26 may have a command input device, such as push buttons similar to that on the media player device 10, or a control ring adapted to receive a user's control commands. The user may adjust the volume, select, play and pause tracks of the audio data in a similar manner as a conventional wireless headphones. The control commands are wirelessly transmitted form the headset 26 to the media player device 10. The media player device 10 receives the commands via the antenna 16, and the main processor 14 thereof processes the commands.

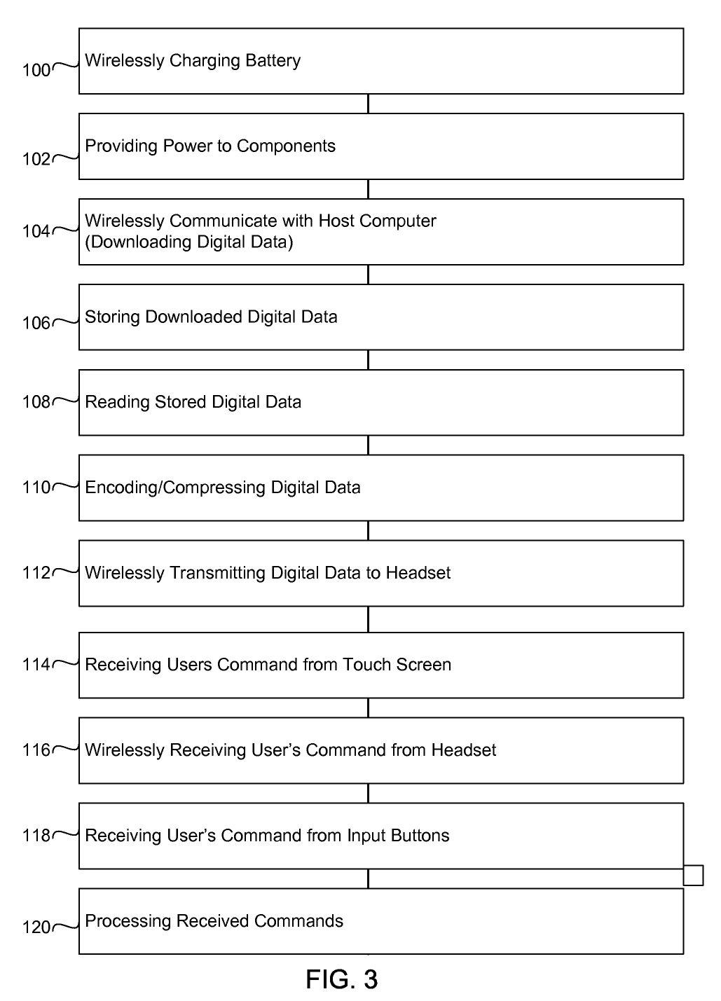

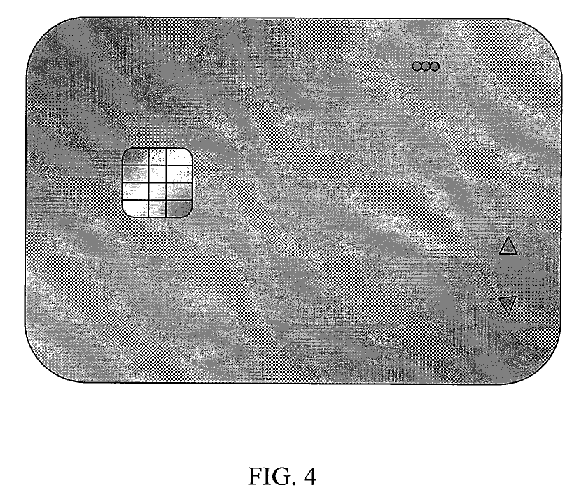

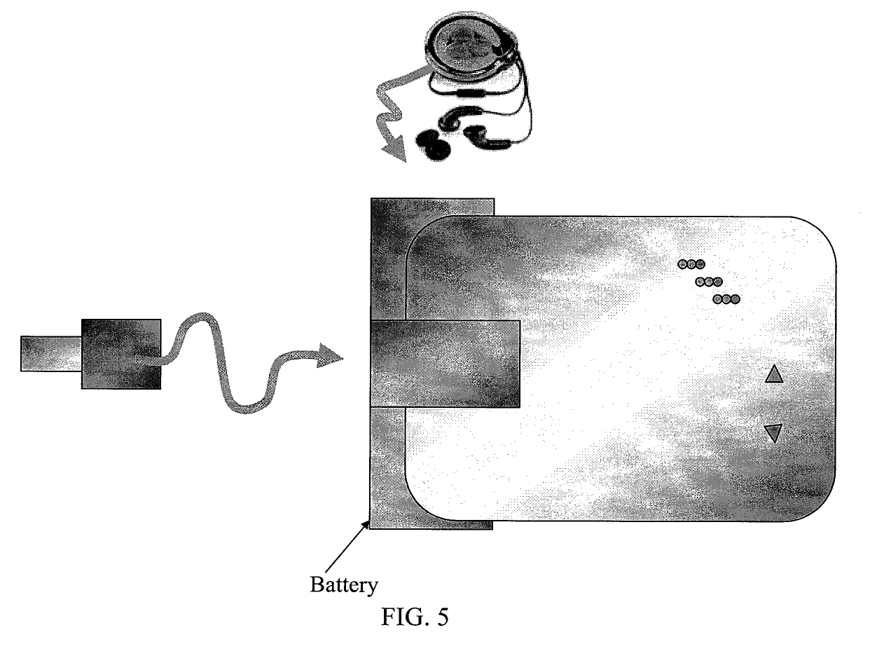

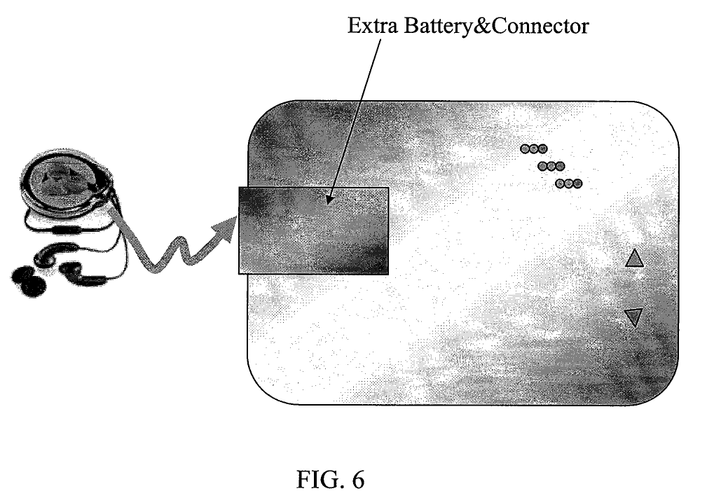

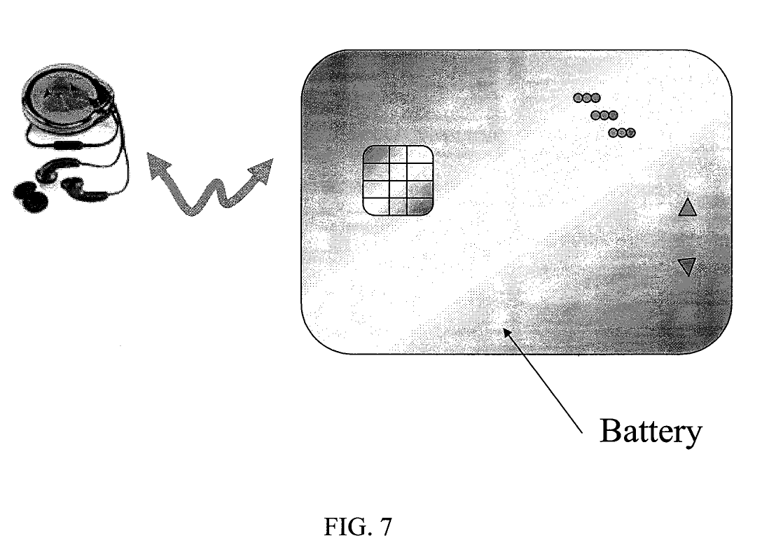

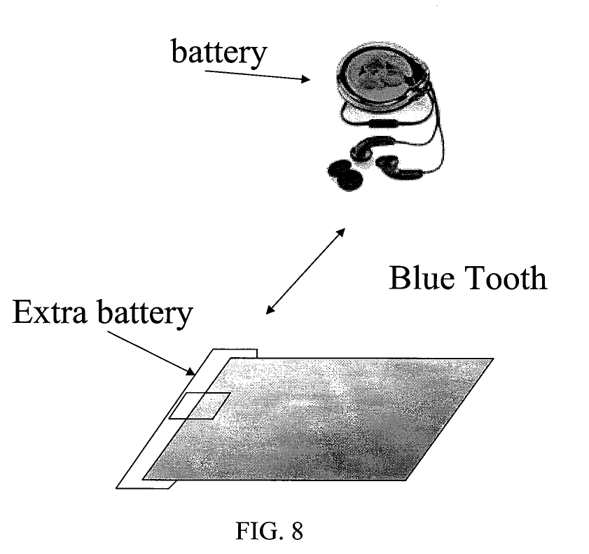

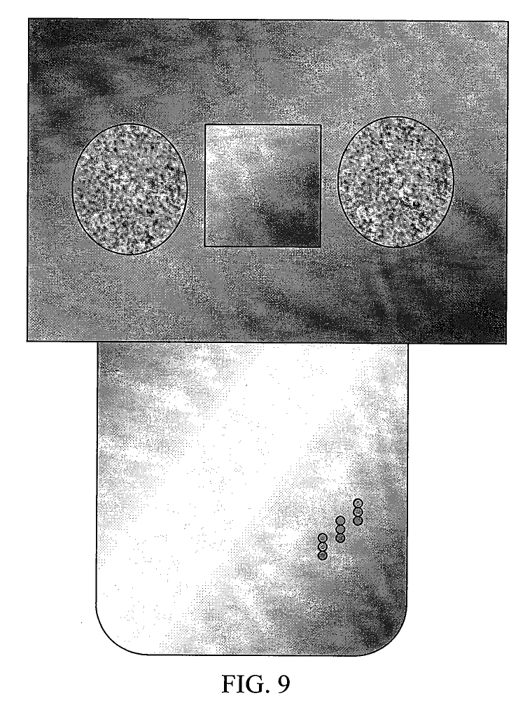

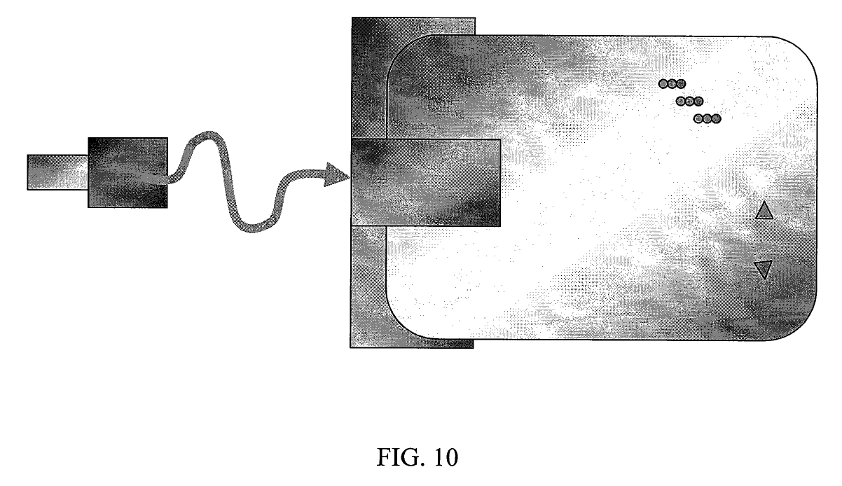

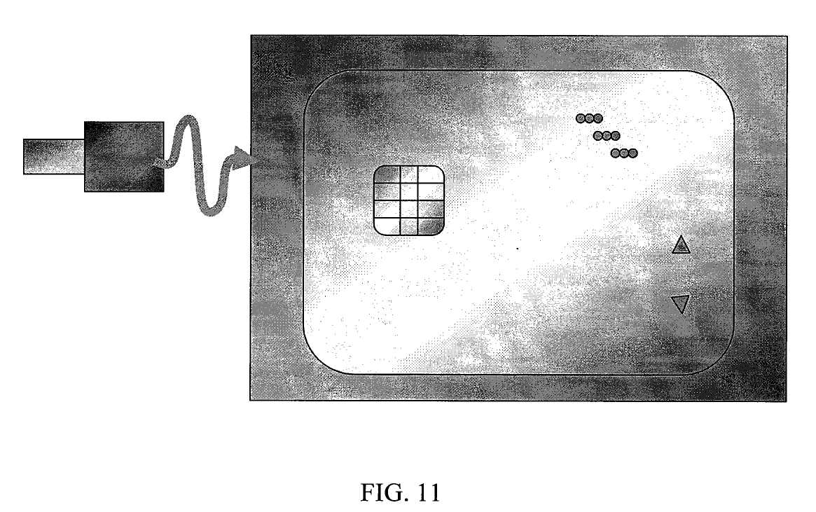

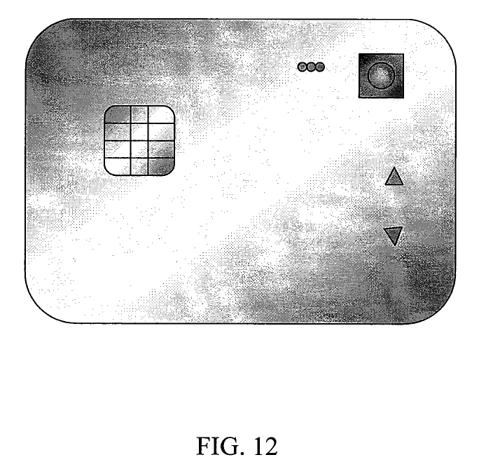

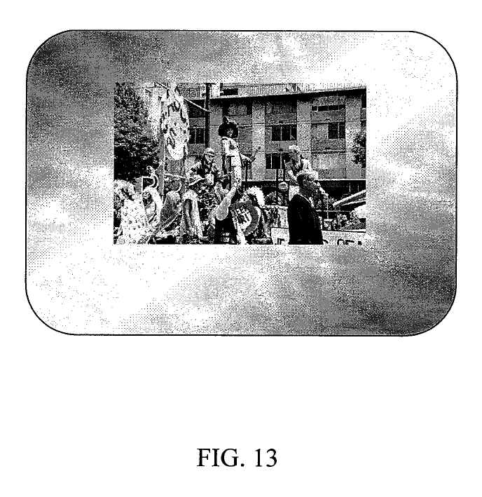

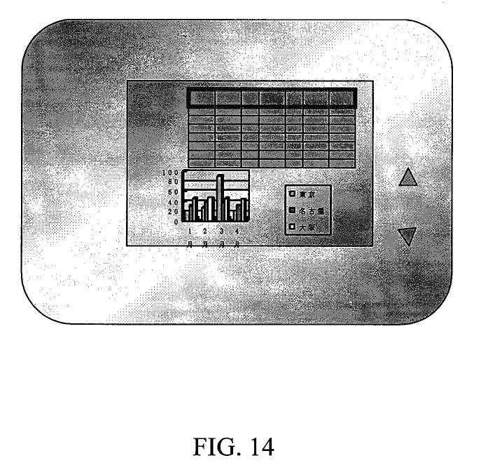

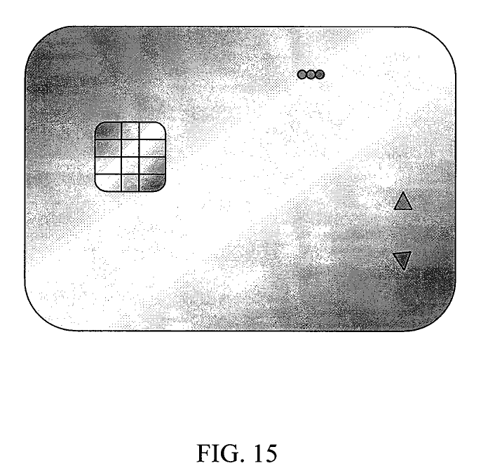

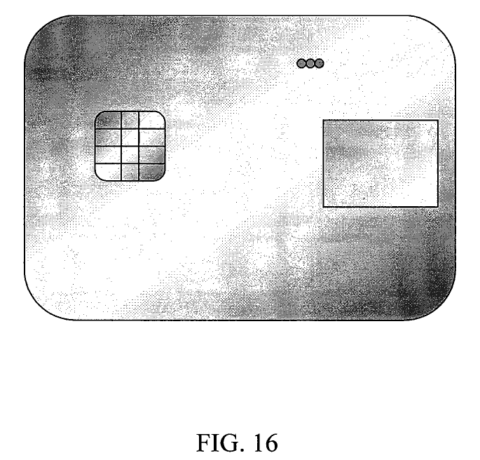

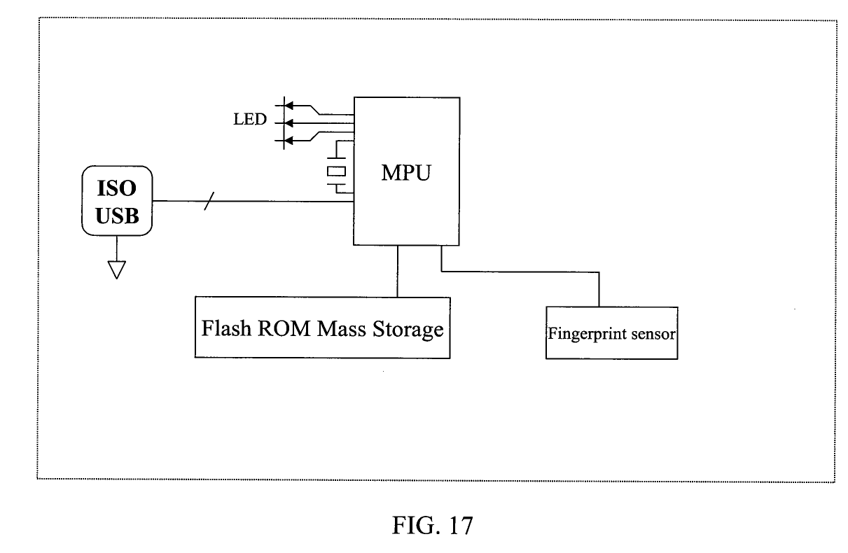

FIG. 3 schematically illustrates a method for operating a media player device fully wirelessly, in accordance with one embodiment of the present invention. The media player device includes a flash memory for storing digital data, at least one processor for processing digital signals and controlling wireless communications, a power circuit including a rechargeable battery, a display, and an antenna for transmitting and receiving digital signals. For example, the media player may be the wireless media player device 10 described above. As shown in FIG. 3, the media player device wirelessly receives power to charge the battery (100). The power is provided to the components of the media player device (102). The media player wirelessly communicates with an external host computer via the antenna and downloads digital data from the host computer (104), and stores the downloaded digital data in the flash memory (106). When the stored data (such as an MP3 file) is to be played, the stored digital data is read from the flash memory (108), optionally encoded or compressed into a selected data format (110), for example, using the SBC, and wirelessly transmitted to an external headset via the antenna (112). At the headset, the received digital data is decoded, and then the audio file is reproduced from speakerphones. The media player device may also receive a user's command by at least one of the following processes. If the display includes a touch screen, receiving a user's commands via the touch screen (114), wirelessly receiving, via the antenna, a user's commands from the external headset (116), and receiving a user's commands via at least one input buttons provided on the media player device (118). The received commands are processed by the main processor and/or the co-processor (120).

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A wireless media player device, comprising:
a flash memory;
a main processor adapted to process digital signals and to control wireless communications, the main processor including a first interface adapted to wirelessly communicate with an external host computer, and a second interface adapted to wirelessly communicate with an external headset;
a signal antenna coupled to the main processor;
a power circuit coupled to the main processor, adapted to provide power to components of the media player device and adapted to store energy;
a wireless charger coupled to the power circuit, adapted to receive power from an external power source, and to charge the power circuit; and
a display provided on a surface of the media player device.

2. The wireless media player device of claim 1, further comprising a touch screen integrated with the display, adapted to receive a user's control commands.

3. The wireless media player device of claim 1, further comprising: at least one control button adapted to input a user's control command.

4. The wireless media player device of claim 3, wherein at least one of the control buttons is coupled to the main processor.

5. The wireless media player device of claim 1, further comprising: a co-processor coupled with the main processor, adapted to control the flash memory.

6. The wireless media player device of claim 5, further comprising: a display controller coupled to the co-processor, adapted to control the display.

7. The wireless media player device of claim 5, further comprising: a global positioning system (GPS) circuit coupled with the co-processor, the co-processor also controlling the GPS circuit.

8. The wireless media player device of claim 1, wherein the media player device is a wearable device, further comprising:
a casing for protecting the wireless media player device, the casing exposing the display on a top surface thereof; and
an attacher adapted to fasten the media player device onto a user such that the display is visible from the user.

9. The wireless media player device of claim 8, wherein the attacher is in a form of a wrist band.

10. The wireless media player device of claim 8, wherein the second interface is further adapted to receive a user's commands wirelessly transmitted from the external headset.

11. A wireless media player apparatus, comprising:
a flash memory for storing digital data;
means for processing digital signals and controlling wireless communications;
means for wirelessly receiving power, storing the power, and providing the power to components of the apparatus;
means for wirelessly communicating with an external host computer and downloading digital data from the host computer;
means for storing the downloaded digital data in the flash memory;
means for reading the stored digital data from the flash memory; means for encoding the read digital data into a selected data format; and
means for wirelessly transmitting the encoded digital data to an external headset.

12. The apparatus of claim 11, further comprising:
means for displaying at least one of an indication of a status of data which is being transmitted or downloaded, an indication of the data stored in the flash memory; and
control button icons.

13. The apparatus of claim 12, wherein the means for displaying further comprises displaying at least one of a current date, a current time, a position of the apparatus based on a global positioning system (GPS) signal, a strength of a signal being received, and/or a battery status.

14. The apparatus of claim 12, further comprising means for receiving a user's command.

15. The apparatus of claim 12, further comprising:
means for protecting the apparatus; and
means for attaching the media player apparatus onto a user such that the means far displaying is visible from the user.

16. The apparatus of claim 15, wherein the means for attaching is in a form of a wrist band.

17. The apparatus of claim 11, further comprising means for receiving the user's commands.

18. The apparatus of claim 17, wherein the means for receiving the user's commands receives the commands wirelessly.

19. The apparatus of claim 17, wherein the means for receiving the user's commands receives the commands via at least one input button provided on the apparatus.

20. A wireless media player system, comprising:
a headset adapted to receive digital audio signals; and
a media player device, including:
a flash memory;
a main processor adapted to process digital signals and to control wireless communications, the main processor including a first interface adapted to wirelessly communicate with an external host computer, and a second interface adapted to wirelessly communicate with the headset;
a signal antenna coupled to the main processor;
a power circuit coupled to the main processor, adapted to provide power to components of the media player device and adapted to store energy;
a wireless charger coupled to the power circuit, adapted to receive power from an external power source, and to charge the power circuit; and
a display provided on a surface of the media player device.

21. The system of claim 20, wherein the headset includes:
a command input device adapted to receive a user's control commands and a wireless interface to transmit the received control commands to the wireless media player device.

22. The system of claim 21, wherein the second interface is further adapted to receive commands wirelessly transmitted from the headset.

23. The wireless media player device of claim 20, wherein the media player device is a wearable device, further comprising:
a casing for protecting the media player device, the casing exposing the display on a top surface thereof; and
an attacher adapted to fasten the media player onto a user such that the display is visible from the user.

24. The wireless media player device of claim 23, wherein the attacher is in a form of a wrist band.

25. A method for operating a media player device including a flash memory for storing digital data, at least one processor for processing digital signals and controlling wireless communications, a power circuit including a rechargeable battery, a display, and an antenna for transmitting and receiving digital signals, the method comprising:
wirelessly receiving power and charging the battery;
providing power to components of the media player device;
wirelessly communicating with an external host computer via the antenna and downloading digital data from the host computer;
storing the downloaded digital data in the flash memory;
reading the stored digital data from the flash memory;
encoding the read digital data into a selected data format; and
wirelessly transmitting, via the antenna, the encoded digital data to an external headset.

26. The method of claim 25, further comprising:
displaying, on the display, at least one of an indication of a status of data which is being transmitted or downloaded, an indication of the data stored in the flash memory, and control button icons.

27. The method of claim 26, further comprising displaying, on the display, at least one of a current date, a current time; a position of the apparatus based on a global positioning system (GPS) signal, a strength of a signal being received, and a battery status.

28. The method of claim 26, wherein the display includes a touch screen, the method further comprising: receiving a user's commands via the touch screen.

29. The method of claim 25, further comprising wirelessly receiving, via the antenna, a user's commands from the external headset.

30. The method of claim 25, further comprising receiving a user's commands via at least one input buttons provided on the media player device.

31. The method of claim 25; wherein the media player device further includes
a casing adapted to protect the media player device; and
an attacher adapted to fastening the media player device onto a user such that the display is visible from the user.

32. The method of claim 31, wherein the attacher is in a form of a wrist band.
